(19) United States
(12) Patent Application Publication
(10) Pub. No.: US 2014/0314952 A1
(43) Pub. Date: Oct. 23, 2014

(54) SPRAY COATING SYSTEM AND METHOD

(71) Applicant: Hartman Walsh Corp., St. Louis, MO (US)

(72) Inventors: Steven D. Chism, Brighton, IL (US); Joshua D. Chism, Fort Collins, CO (US); Owen Hattemar, Pierdido Beach, AL (US); Andrew Jenkins, Brighton, IL (US)

(73) Assignee: Hartman Walsh Corp., St. Louis, MO (US)

(21) Appl. No.: 14/188,040

(22) Filed: Feb. 24, 2014

Related U.S. Application Data
(60) Provisional application No. 61/812,804, filed on Apr. 17, 2013.

(51) Int. Cl. B05B 3/02; B05B 7/02

(52) U.S. Cl. CPC B05B 3/02; B05B 7/02
USPC 427/236; 239/226

(57) ABSTRACT

A spray coating system includes a rotating spray head and a transfer assembly. The spray head is coupled with a spray nozzle that directs spraying of a fluid multi-component product onto an interior surface of a structure. The spray head rotates around a longitudinal axis in order to cause the spray nozzle to also rotate around the longitudinal axis while spraying the multi-component product onto the interior surface of the structure. The transfer assembly is fluidly coupled with the spray nozzle and supplies plural different fluids that form the multi-component product to the spray nozzle. The transfer assembly supplies the different fluids that form the multi-component product to the spray nozzle without mixing the different fluids with each other prior to the different fluids being disposed proximate to the at least one spray nozzle.

### CROSS-REFERENCE TO RELATED APPLICATIONS

This application claims priority to U.S. Provisional Application Ser. No. 61/812,804, which was filed on 17 Apr. 2013, and the entire contents of which are incorporated by reference.

### FIELD

The inventive subject matter described herein relates generally to systems and methods for spraying fluids onto surfaces of structures, such as systems and methods that apply multi-component compounds onto interior surfaces of structures such as cylindrical conduits.

### BACKGROUND

Cylindrical structures may be used as conduits for controlling the flow of fluids to and from locations. For example, power plants may have relatively large conduits that direct the flow of water to and from the plants to cool systems within the plants. The interior surfaces of these conduits are typically coated with a multi-component compound to provide a smooth interior surface of the conduits, which allows the fluids to flow through the conduits more easily. This compound may also prevent or reduce corrosion of the conduits and extend the useful life of the conduits. Reducing the friction or eddy currents generated by friction between the fluids and the interior surfaces of the conduits can result in reduced wear on pumps that push or draw the fluids through the conduits, increased flow of the fluids, reduced corrosion of the conduits, improved energy transfer of fluids through the conduits, and other benefits.

Currently, the interior surfaces of the conduits are coated with multi-component compounds that are formed from two or more fluids having relatively short pot lives when mixed together. For example, these compounds may be formed from multiple fluids that, when mixed together, begin to cure, set, dry, harden, or otherwise coagulate. As a result, these fluids may not be mixed very long before the fluids are applied as the multi-component compound onto the interior surfaces of the conduits.

In order to apply the multi-component compounds, some known techniques include mixing relatively small amounts of the fluids that form the compound and manually spraying the compound by hand along the interior surface of a conduit. This technique is prone to human error in the amount of compound applied to the interior surfaces of the conduit. This error can result in coatings of the compound not having a constant thickness, and can cause an uneven interior surface in the conduit that decreases the flow efficiencies of fluids through the conduit.

### BRIEF DESCRIPTION

In an embodiment, a spray coating system includes a rotating spray head and a transfer assembly. The spray head is coupled with at least one spray nozzle that is configured to direct spraying of a fluid multi-component product onto an interior surface of a structure. The spray head is configured to rotate around a longitudinal axis in order to cause the spray nozzle(s) to also rotate around the longitudinal axis while spraying the multi-component product onto the interior surface of the structure. The transfer assembly is fluidly coupled with the at least one spray nozzle and is configured to supply plural different fluids that form the multi-component product to the at least one spray nozzle for spraying the multi-component product onto the interior surface of the structure. The transfer assembly is configured to supply the different fluids that form the multi-component product to the at least one spray nozzle without mixing the different fluids with each other prior to the different fluids being disposed proximate to the at least one spray nozzle.

In one aspect, the different fluids are not mixed with each other until the fluids are disposed in a location that is upstream of and closer to the nozzle(s) than the containers and/or transfer assembly.

In one aspect, the different fluids are not mixed with each other until the fluids are disposed within the nozzle(s).

In one aspect, the different fluids are not mixed with each other until the fluids are disposed outside of (e.g., downstream of) the nozzle(s).

In one aspect, the spray head is configured to be rotated by rotation of a spray head axle and the transfer assembly is configured to convey the different fluids that form the multi-component product at least one of through or along the spray head axle as the spray head axle rotates without also rotating respective different supply containers of the different fluids.

In one aspect, the system also includes a transport assembly configured to propel the spray head and the transfer assembly in one or more directions oriented parallel to the longitudinal axis as the spray head rotates and the at least one spray nozzle sprays the multi-component product onto the interior surface of the structure.

In one aspect, the system also includes a control assembly configured to control rotation of the spray head and movement of the spray head and the transfer assembly by the transport assembly. The control assembly can be configured to coordinate a speed of rotation of the spray head with a speed of movement at which the transport assembly moves the spray head and the transfer assembly.

In one aspect, the control assembly is configured to coordinate the speed of rotation with the speed of movement in order to apply the multi-component product onto the interior surface of the structure at a designated coating thickness.

In one aspect, the transport assembly includes a spark-free air motor that is pneumatically powered and controlled to propel the spray head and the transfer assembly.

In one aspect, the spray head is coupled with the at least one spray nozzle by at least one arm. The arm is configured to be moved relative to the spray head to control an angle at which the at least one spray nozzle is oriented relative to the interior surface of the structure.

In one aspect, the system also includes a stanchion coupled with a spray head axle that rotates the spray head. The stanchion is configured to raise or lower the spray head axle and the spray head relative to the interior surface of the structure.

In one aspect, each of the at least one spray nozzle is supplied with the different fluids such that each of the at least one spray nozzle concurrently sprays the different fluids onto the interior surface of the structure.

In an embodiment, a method for applying a fluid multi-component product to an interior surface of a structure is provided. The method includes rotating a spray head around a longitudinal axis. The spray head is coupled with at least one spray nozzle. The method also includes supplying the at least one spray nozzle with plural different fluids that form the multi-component product via a transfer assembly and spraying the different fluids that form the multi-component product onto the interior surface of the structure from the at least one spray nozzle. The different fluids are sprayed from the at least one spray nozzle as the at least one spray nozzle rotates around the longitudinal axis. The different fluids that form the multi-component product are supplied to the at least one spray nozzle without mixing the different fluids with each other prior to the different fluids being disposed proximate to the at least one spray nozzle.

In one aspect, the different fluids are supplied from different respective supply containers without also rotating the supply containers.

In one aspect, the method also includes propelling the spray head and the transfer assembly in one or more directions oriented parallel to the longitudinal axis as the spray head rotates and the at least one spray nozzle sprays the multi-component product onto the interior surface of the structure.

In one aspect, rotating the spray head and propelling the spray head and the transfer assembly includes coordinating a speed of rotation of the spray head with a speed of movement at which the transport assembly moves the spray head and the transfer assembly.

In one aspect, the speed of rotation is coordinated with the speed of movement in order to apply the multi-component product onto the interior surface of the structure at a designated coating thickness.

In one aspect, the method also includes modifying an angle at which the at least one spray nozzle is oriented relative to the interior surface of the structure.

In one aspect, the method also includes at least one or raising or lowering the spray head relative to the interior surface of the structure.

In an embodiment, a system (e.g., a spray coating system) includes a transport assembly, a spray head axle, and a spray head. The transport assembly includes a mobile platform and a motor configured to propel the platform along a designated direction. The spray head axle is rotatably coupled with the transport assembly and is configured to rotate around an axis that is parallel to the designated direction. The spray head is coupled with the spray head axle and includes at least one spray nozzle. The spray head and the at least one spray nozzle are configured to be rotated around the axis by rotation of the spray head axle. The transport assembly is configured to propel the platform, the spray head axle, and the spray head along the designated direction while the spray head and the at least one spray nozzle are rotated around the axis. The at least one spray nozzle is configured to apply one or more fluids to an interior surface of a structure in which the transport assembly, the spray head axle, and the spray head are disposed.

In one aspect, the system also includes a transfer assembly fluidly coupled with the at least one spray nozzle. The transfer assembly is configured to supply plural different fluids that form a multi-component product to the at least one spray nozzle for spraying the multi-component product onto the interior surface of the structure. The transfer assembly is configured to supply the different fluids without mixing the different fluids with each other prior to the different fluids being disposed proximate to the at least one spray nozzle.

In one aspect, the spray head is configured to be rotated by rotation of a spray head axle and the transfer assembly is configured to convey the different fluids that form the multi-component product at least one of through or along the spray head axle as the spray head axle rotates without also rotating respective different supply containers of the different fluids.

In one aspect, the system also includes a control assembly configured to control rotation of the spray head and movement of the spray head and the transfer assembly by the transport assembly. The control assembly is configured to coordinate a speed of rotation of the spray head with a speed of movement at which the transport assembly moves the spray head and the transfer assembly.

In one aspect, the control assembly is configured to coordinate the speed of rotation with the speed of movement in order to apply the multi-component product onto the interior surface of the structure at a designated coating thickness.

In one aspect, the transport assembly includes a spark-free air motor that is pneumatically powered and controlled to propel the spray head and the transfer assembly.

In one aspect, the spray head is coupled with the at least one spray nozzle by at least one arm. The arm is configured to be moved relative to the spray head to control an angle at which the at least one spray nozzle is oriented relative to the interior surface of the structure.

In one aspect, the system also includes a stanchion coupled with a spray head axle that rotates the spray head. The stanchion is configured to raise or lower the spray head axle and the spray head relative to the interior surface of the structure.

### BRIEF DESCRIPTION OF THE DRAWINGS

FIG. 1 is a schematic illustration of an embodiment of a spray coating system in operation within a structure.

FIG. 2 is a schematic illustration of the spray coating system shown in FIG. 1.

FIG. 3 is a cross-sectional view of one example of a transfer assembly.

FIG. 4 is a view of an outlet end of the transfer assembly shown in FIG. 3.

FIG. 5 is a perspective view of an embodiment of a spray coating system.

FIG. 6 is a flowchart of an embodiment of a method for applying a multi-component compound onto an interior surface of a structure.

FIG. 7 is a schematic illustration of the system shown in FIG. 1 with one example of a steering assembly.

FIG. 8 is a side view of a turning assembly of the steering assembly shown in FIG. 7 according to one example of the inventive subject matter described herein.

FIG. 9 is a top view of a steering device and the turning assembly of the steering assembly shown in FIG. 8.

### DETAILED DESCRIPTION

The foregoing summary, as well as the following detailed description of certain embodiments of the inventive subject matter, will be better understood when read in conjunction with the appended drawings. The various embodiments are not limited to the arrangements and instrumentality shown in the drawings. As used herein, an element or step recited in the singular and proceeded with the word “a” or “an” should be understood as not excluding plural of said elements or steps, unless such exclusion is explicitly stated. Furthermore, references to “one embodiment” or “an embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

It should be noted that although one or more embodiments may be described in connection with systems and methods spraying applying multi-component compounds having relatively short pot lives onto interior surfaces of structures, not all embodiments of the inventive subject matter are limited in this manner. For example, systems and methods described herein may be used to apply single component fluids, to apply the compounds or fluids in a manner other than spraying (e.g., by using a brush, roller, or other technique), to apply the compounds or fluids to exterior surfaces, or the like.

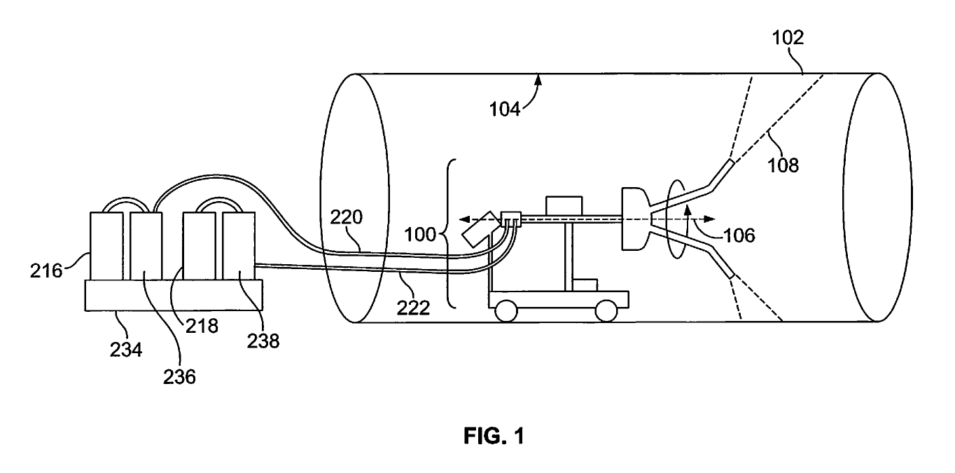

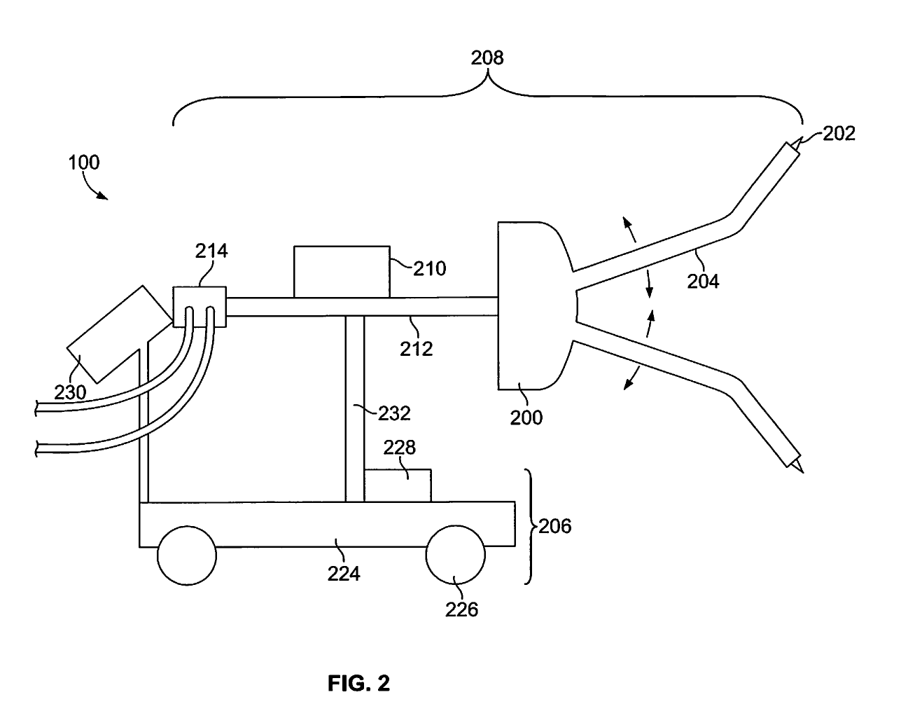

FIG. 1 is a schematic illustration of an embodiment of a spray coating system 100 in operation within a structure 102. FIG. 2 is a schematic illustration of the spray coating system 100 shown in FIG. 1. The structure 102 is shown as a conduit, such as a cylindrical or other shaped conduit for the flow of a fluid (e.g., air, water, or the like). Alternatively, the structure 102 may be another structure and/or of a different shape. While the system 100 is not shown in dashed lines in FIG. 1, the system 100 is disposed within the structure 102 such that the interior surface 104 of the structure 102 at least partially surrounds the system 100 during operation.

The system 100 moves within the structure 102 in order to apply fluids onto an interior surface 104 of the structure 102. In an embodiment, the system 100 sprays the fluids onto the interior surface 104. The fluids that are applied to the interior surface 104 may include a multi-component compound 108, such as a coating that seals and/or reduces the coefficient of friction of the interior surface 104. The term “multi-component compound” may refer to a fluid compound formed from two or more fluids and that has a relatively short pot life. For example, a multi-component compound may be formed from a mixture of two or more different fluids that set, cure, coagulate, dry, or otherwise solidify in a relatively rapid manner. The pot life of the multi-component compound may be sufficiently short that the system 100 is unable to pre-mix the fluids used to form the compound before channeling the compound through the system 100 and out of spray nozzles (shown and described below) without the compound clogging one or more lines, hoses, nozzles, or other conduits of the system 100.

As shown in FIG. 2, the system 100 includes a rotating assembly 208 that rotates to spray the fluids onto the interior surface 104. The rotating assembly 208 includes a spray head 200 coupled with spray nozzles 202. The nozzles 202 are connected with the spray head 200 by elongated arms 204. While two nozzles 202 are shown in FIGS. 1 and 2, optionally, a single nozzle 202 or more than two nozzles may be used. A motor 210 of the rotating assembly 208 may be coupled with a spray head axle 212, which is connected with the spray head 200. The motor 210 rotates the axle 212, which rotates the spray head 200, the arms 204, and the nozzles 202.

The nozzles 202 apply the fluids to the interior surface 104 of the structure 102 by spraying the fluids onto the interior surface 104 as the nozzles 202, arms 204, and spray head 200 are rotated around a longitudinal axis 106 (shown in FIG. 1). While the nozzles 202, arms 204, and spray head 200 are shown as rotating in a counter-clockwise direction in FIG. 1, the nozzles 202, arms 204, and spray head 200 may rotate in a clockwise direction.

In one aspect, the arms 204 may be moveable with respect to the spray head 200. The arms 204 may move toward or away from each other along the directions indicated in FIG. 2. An operator of the system 100 can change the relative positions of the arms 204 to change the positions of the nozzles 202 relative to the interior surface 104 of the structure 102. For example, for smaller structures 102, the arms 204 may be moved closer together. For smaller spray patterns of the compound onto the interior surface 104, the arms 204 may be moved farther apart (and closer to the interior surface 104).

The arms 204 may be individually controlled to allow an operator of the system 100 to position the arms 204 in different locations on the spray head 200. For example, the angle at which one arm 204 is located may be different from the angle at which another arm 204 is located.

The illustrated embodiment of the system 100 includes a stanchion 232 coupled with the spray head axle 212. The stanchion 232 can raise or lower the spray head axle 212 and the spray head 200. For example, the stanchion 232 may telescope upward or downward to move the axle 212, the spray head 200, and the nozzles 202 toward or away from the interior surface 104 of the structure 102.

A transfer assembly 214 is fluidly coupled with the spray nozzles 202 and with one or more containers 216, 218 that hold the fluids sprayed by the system 100 onto the interior surface 104 of the structure 102. With respect to the spray nozzles 202, the transfer assembly 214 may be fluidly coupled with the spray nozzles 202 by one or more conduits (e.g., hoses, channels, and the like, not shown in FIG. 2). With respect to the containers 216, 218, the transfer assembly 214 may be fluidly coupled with the containers 216, 218 by one or more conduits 220, 222. The different containers 216, 218 may hold different fluids that are combined to form the multi-component compound 108. While only two containers 216, 218 are shown, there may be a different number of containers 216 and/or 218. The containers 216, 218 are shown as being disposed onboard a trailer 234 that is separate from the system 100. The trailer 234 may be stationary or may move with the system 100. For example, the trailer 234 may remain in the same location while the system 100 moves through the structure 102. Optionally, the trailer 234 may include wheels, treads, or the like, to allow the trailer 234 to move within the structure 102. The trailer 234 may be located inside the same structure 102 as the system 100 or may be located outside of the structure 102. The trailer 234 can include pumps 236, 238 that force the fluids in the containers 216, 218 through the conduits 220, 222 to the system 100. Although not shown in FIG. 2, the trailer 234 can include one or more additional containers and/or pumps that supply another fluid, such as a solvent, to the system 100. In another aspect, the containers 216, 218 may be disposed onboard the system 100 by being supported by a platform 224 of the system 100.

The transfer assembly 214 supplies the different fluids held in the containers 216, 218 to the spray nozzles 202 for spraying as the multi-component product 108 onto the interior surface 104 of the structure 102 without mixing the different fluids with each other just prior to the different fluids being received by the spray nozzles 202. For example, different flow paths for the respective fluids may be established from the containers 216, 218, through the transfer assembly 214, and to the nozzles 202. The different flow paths may combine or intersect just prior to reaching the nozzles 202 such that the different fluids that are flowing in the different flow paths mix to form the multi-component compound just prior to the compound being received by the nozzles 202. The different flow paths may not intersect or combine until being proximate to the nozzles 202 to prevent the multi-component compound from being formed too soon and thickening, drying, or otherwise coagulating prior to being applied onto the interior surface 104. For example, the flow paths may combine proximate to the nozzles 202 when the flow paths intersect and the different fluids first mix with each other in a location that is upstream of the nozzles 202 (along flow directions of the fluids) but that is closer to the nozzles 202 than the spray head 200 and/or transfer assembly 214. In another example, the flow paths may combine in a location that is proximate to the nozzles 202 when the flow paths intersect and the different fluids first mix with each other inside of the nozzles 202. As another example, the flow paths may combine proximate to the nozzles 202 when each one of the nozzles 202 separately sprays the different fluids such that the fluids first mix with each other in a location that is outside of the nozzles 202 (as the fluids are being sprayed onto the interior surface 104).

The transfer assembly 214 permits the fluids used to form the multi-component product to be supplied from the containers 216, 218 and through the rotating assembly 208 to the nozzles 202 while the rotating assembly 208 rotates around the longitudinal axis 106 without previously mixing the fluids and/or without also rotating the containers 216, 218. For example, the transfer assembly 214 allows the spray head 200 to be rotated by rotation of the spray head axle 212 while the transfer assembly 214 conveys or directs the different fluids that form the multi-component product through and/or along the spray head axle 212 as the spray head axle 212 rotates the spray head 200 without also rotating the containers 216, 218. In doing so, the transfer assembly 214 can allow the rotating assembly 208 to rotate the spray head 200 through several complete 360 degree rotations without reversing the direction of rotation. For example, the transfer assembly 214 may permit the spray head 200 to be continually rotated without twisting the conduits or flow paths that extend from the containers 216, 218 to the nozzles 202.

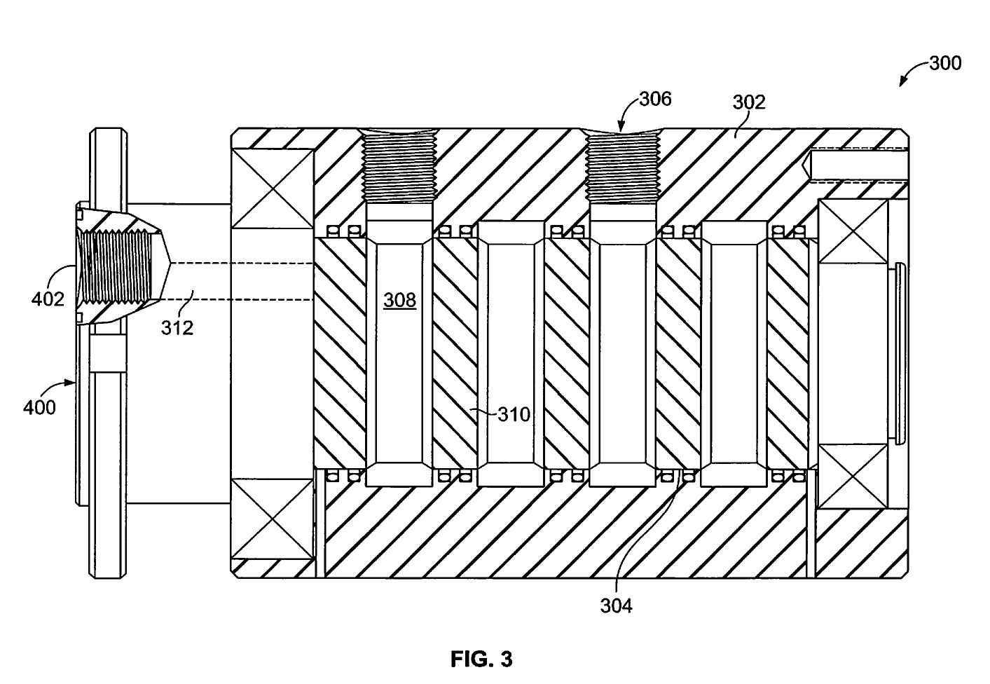

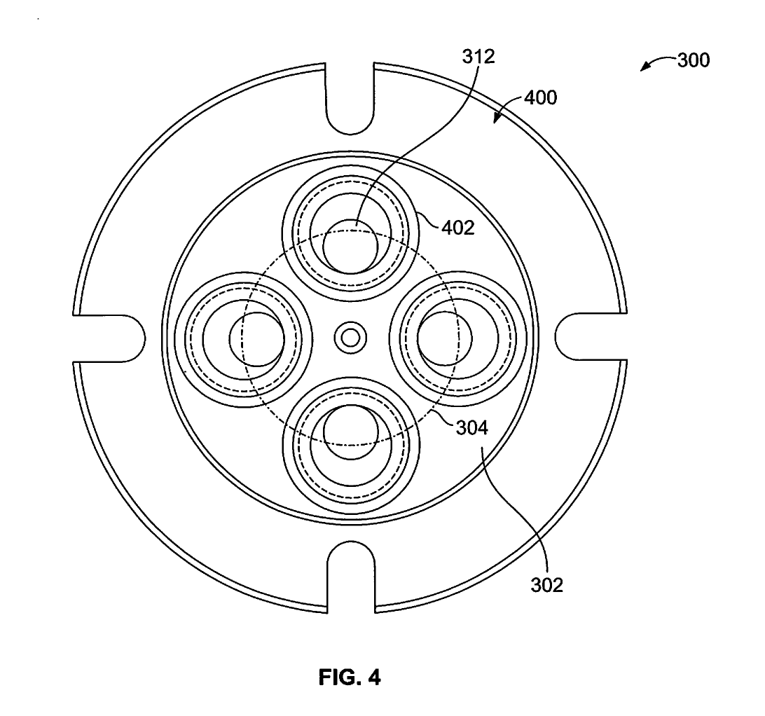

FIG. 3 is a cross-sectional view of one example of a transfer assembly 300. FIG. 4 is a view of an outlet end 400 of the transfer assembly 300 shown in FIG. 3. The transfer assembly 300 may be used as the transfer assembly 214 shown in FIG. 2. Alternatively, another transfer assembly may be used in the system 100.

The transfer assembly 300 can include a body that rotates with the axle 212 and spray head 200 and another body that does not rotate or move relative to the containers 216, 218 from which the fluids are obtained. These two bodies may be fluidly coupled with each other and with the nozzles 202 and the containers 216, 218 in order to transfer the fluids from the containers 216, 218 to the nozzles 202 without twisting any conduits that supply the fluids from the containers 216, 218 and/or to the nozzles 202. The rotating body 400 of the transfer assembly 300 can be fluidly coupled with the nozzles 202 while the stationary body 302 of the transfer assembly 300 can be fluidly coupled with the containers 216, 218. These two bodies 302, 400 may then transfer the fluids from the containers 216, 218 between each other and to the nozzles 202.

In the illustrated embodiment, the transfer assembly 300 includes an outer stationary body 302 and an internal rotating body 304. The stationary body 302 may not rotate during operation of the system 100 and the transfer assembly 300 while the rotating body 304 rotates with the axle 212 and spray head 200. The rotating body 304 may include the outlet end 400 that is connected with the axle 212 such that rotation of the axle 212 causes rotation of the rotating body 304 inside the stationary body 302.

The stationary body 302 includes several inlet ports 306 that are fluidly coupled with the containers 216, 218. For example, separate conduits may couple different containers 216, 218 with different inlet ports 306. During operation, the stationary body 302 may not move (e.g., not rotate) relative to the containers 216, 218 so that these conduits do not become twisted. The inlet ports 306 are fluidly coupled with internal chambers 308. These internal chambers 308 may be separate from each other so that the fluid in each chamber 308 does not mix with the fluid in one or more other chambers 308. Although only two inlet ports 306 are shown in FIG. 3, the transfer assembly 200 may include another quantity of inlet ports 306. Although four chambers 308 are shown, a different quantity of chambers 308 may be used. The inlet ports 306 that are fluidly coupled with the two additional chambers 308 are not visible in the view of FIG. 3.

The internal chambers 308 may be partially disposed in each of the stationary body 302 and the rotating body 304. Internal walls 310 may separate the chambers 308 from each other inside the rotating body 304. These internal walls 310 can be aligned with the different inlet ports 306 to keep the chambers 308 aligned with the respective inlet ports 306 but separate from each other. The internal walls 310 rotate with the rotating body 304 while staying aligned with the respective inlet ports 306 in order to keep the different fluids in the chambers 308 separate from each other during operation.

Several outlet ports 402 are accessible at the end 400 of the transfer assembly 300. These outlet ports 402 are fluidly coupled with different ones of the internal chambers 308 by conduits 312. These conduits 312 may be disposed inside of the transfer assembly 300 and may be referred to as internal conduits 312. Although only one conduit 312 and one outlet port 402 are shown in FIG. 3, each of the internal chambers 308 may be associated (e.g., fluidly coupled) with a different conduit 312 and a different outlet port 402. The outlet ports 402 extend through the stationary body 302 and, as a result, may not rotate or move with the rotating body 304. At least a portion of the conduits 312 that are disposed within the rotating body 304 may rotate with the rotating body 304 while another portion of the conduits 312 may remain stationary in the stationary body 302.

In operation, the containers 216, 218 may be fluidly coupled with one or more pumps that act to move the fluids in the containers 216, 218 to the inlet ports 306, into the respective internal chambers 308, through the respective conduits 312, and out of the respective outlet ports 402. These pumps may be disposed onboard the same trailer 234 that carries the containers 216, 218. The number and/or type of pumps used for each the different fluids may differ from one another to cause the volumes or flows of the fluids from the containers 216, 218 to differ from each other. Because the internal walls 310 separate the chambers 308 inside the transfer assembly 300 while the rotating body 304 rotates within the stationary body 302, the fluids may remain separate from each other inside the transfer assembly 300. The fluids may separately flow through the respective conduits 312 to the associated outlet ports 402.

The outlet ports 402 are separately connected with different nozzles 202 to define parts of the flow paths of the different fluids from the transfer assembly 300 to the nozzles 202. The outlet ports 402 are included in a part of the rotating body 304 that defines the end 402 such that the outlet ports 402 rotate with the axle 212 and the spray head 200. The flow path for each fluid may therefore be kept separate from the flow paths of other fluids from the containers 216, 218 to a location that is just upstream of the nozzles 202 (or inside the nozzles 202 or just downstream of the nozzles 202) during rotation of the spray head 200, axle 212, and nozzles 202, as described above.

The system 100 may move in one or more directions through the structure 102 while the nozzles 202 are rotated and are spraying the multi-component compound 108 onto the interior surface 104 of the structure 102. For example, the system 100 can include a transport assembly 206 that propels the system 100 in one or more directions (e.g., forward and/or backward) within the structure 102. The directions in which the transport assembly 206 moves the system 100 may be parallel to (e.g., not transverse to) the longitudinal axis 106, such as along the length of the structure 102. In the illustrated embodiment, the transport assembly 206 includes the platform 224 joined with wheels 226. A motor 228 of the transport assembly 206 generates tractive effort to rotate one or more of the wheels 226 to propel the system 100. Alternatively, the wheels 226 may be replaced with treads or other components on which the system 100 can propel.

In one aspect, the motor 210 and/or 228 may be a spark-free motor that is powered such that no electric sparks are generated by the motor 210 and/or 228. For example, the motor 210 and/or 228 may be pneumatically powered by an internal and/or external source of pressurized air (or other gas). Using a spark-free motor can provide for increased safety during operation of the system 100. The system 100 may be used in relatively confined spaces having reduced airflow (relative to outside of the structure 102). Spraying of the multi-component compound can cause flammable fumes to build up in the structure 102 that would otherwise combust if exposed to a source of energy, such as a spark from a motor or a flame. Use of a spark-free motor 210 and/or 228 eliminates or substantially reduces this risk.

Returning to the discussion of the system 100 schematically shown in FIGS. 1 and 2, a control assembly 230 is used to manually and/or automatically control operations of the system 100. The control assembly 230 can include or represent one or more processors, controllers, valves, switches, levers, or the like, that are used to control operations of the system 100 in an autonomous and/or manual manner. In one aspect, the control assembly 230 may be used to automatically control a speed of rotation of the spray head 200 (and axle 212 and nozzles 202) and a speed of movement of the transport assembly 206. The speed of movement represents the speed at which the transport assembly 206 conveys the system 100 along the structure 102. The control assembly 230 can coordinate the speed of rotation and the speed of movement so that a desired (e.g., designated) thickness of the multi-component compound is sprayed onto the interior surface of the structure 102 by the system 100 as the system 100 moves through the structure 102.

By “coordinate,” it is meant that the control assembly 230 may base the speed of rotation on the speed of movement (and/or base the speed of movement on the speed of rotation) such that a change in the speed of movement causes a corresponding (e.g., same, proportional, or other) change in the speed of rotation (and vice-versa). The speeds of rotation and movement may be determined in order to achieve a designated coating thickness that is applied by the system 100 onto the interior surface of the structure 102 based on operational parameters of the system 100. While the rotation speed and movement speed may be based on each other, these speeds may be independently controlled. For example, an operator may change the speed of rotation or movement without also changing the other of the speed of rotation or movements.

These parameters include, but are not limited to, the positions of the nozzles 202 relative to the interior surface of the structure 102 (e.g., the angles at which the arms 204 are oriented, the distance from the nozzles 202 to the interior surface, the orientation of the nozzles 202, and the like), the physical characteristics of the fluids and/or multi-component compound being sprayed by the system 100 (e.g., the viscosity of the fluids and/or compound), the pressure at which the fluids and/or compound is sprayed by the nozzles 202, the flow rate or volume at which the fluids are supplied to the nozzles 202, the positions (e.g., angles, heights, and the like) of the arms 204, the curing time of the multi-component compound, the spray pattern used by the nozzles 202 to apply the fluids and/or compound, and the like.

For a designated coating thickness that is to be applied by the system 100, changing one or more of these parameters may cause the control assembly 230 to also change the speed of rotation and/or the speed of movement. For example, increasing the speed of rotation may cause the control assembly 230 to also increase the speed of movement. Increasing the speed of movement may cause the control assembly 230 to also increase the speed of rotation. Conversely, decreasing the speed of rotation or movement may cause the control assembly 230 to also decrease the other of the speed of rotation or the speed of movement. If the speeds of rotation and movement are not coordinated with each other or otherwise based on each other, the multi-component compound may not be applied to the interior surface 104 at the designated coating thickness. Additionally, if the speeds of rotation and movement are not coordinated with each other or otherwise based on each other, the multi-component compound may not be applied evenly onto the interior surface 104. For example, ridges or other uneven portions of the coating on the interior surface 104 may be formed if the speed of rotation or movement is too slow relative to the other of the speed of rotation or movement. The application of the compound by one rotation of the nozzles 202 may overlap the application of the compound by a previous rotation of the nozzles 202, which can cause such ridges or other uneven portions. In applications where the interior surface 104 is desired to be as smooth as possible (e.g., where the structure 102 is used as a conduit for a moving fluid such as water), these ridges or other uneven portions may be detrimental to the flow of the fluid through the structure 102.

In one aspect, the system 100 may include an auto-steering apparatus that ensures the system 100 is traveling parallel or substantially parallel to the center of the structure 102. This apparatus may include one or more sensors (e.g., ultrasound transducers, radar sensors, or other sensors) that detect how far the system 100 is from the interior surface 104 of the structure 102 in one or more directions. Based on the measured distances and/or changes in these distances, the apparatus can automatically change the steering of the system 100 so that the system 100 moves toward the center of the structure 102. For example, if the system 100 is traveling in a rightward direction toward one side of the structure 102, the auto-steering apparatus may detect that the distance between the system 100 and the right side of the structure 102 is decreasing while the distance between the system 100 and the opposite left side of the structure 102 is increasing. In response to this detection, the auto-steering apparatus may turn the wheels of the system 100 in order to steer the system 100 away from the right side of the structure 102 and more toward the center of the structure 102. The apparatus may continue to monitor the distances between the system 100 and the structure 102 and repeatedly auto-correct the steering of the system 100 so that the system 100 substantially remains in the center of the structure 102.

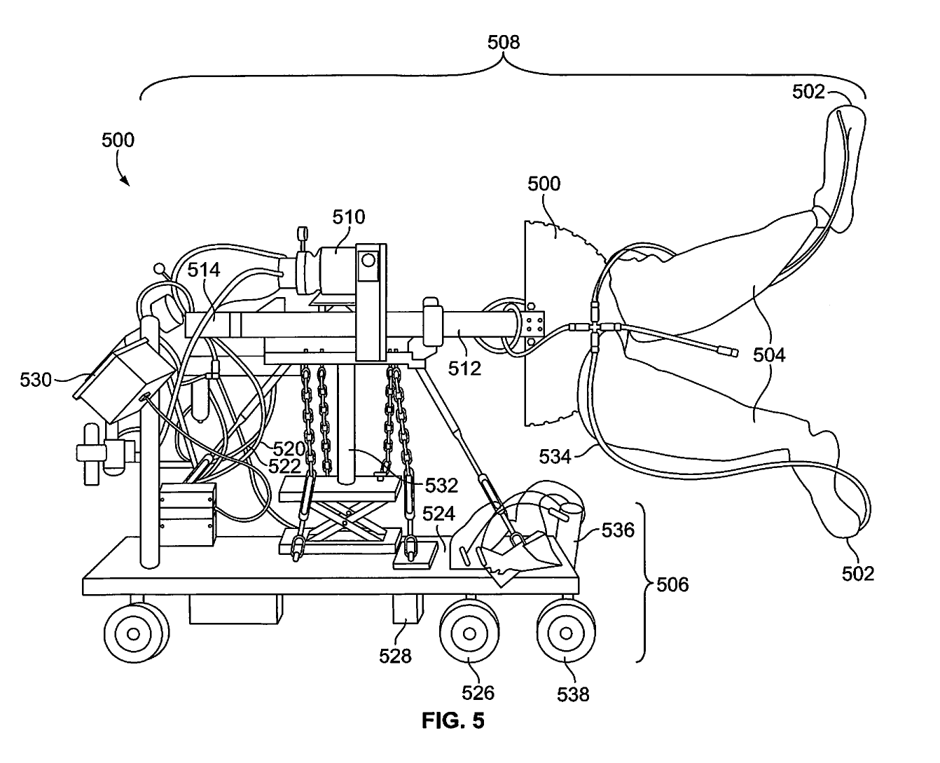

FIG. 5 is a perspective view of an embodiment of a spray coating system 500. The system 500 may represent the same or different system as that shown in FIG. 1. Similar to the system 100, the system 500 includes a spray head 500 (e.g., spray head 200), nozzles 502 (e.g., nozzles 202), arms 504 (e.g., arms 204), a transport assembly 506 (e.g., transport assembly 206), a rotating assembly 508 (e.g., rotating assembly 208), motors 510, 528 (e.g., motors 210, 228), a spray head axle 512 (e.g., spray head axle 212), a transfer assembly 514 (e.g., transfer assembly 214), conduits 520, 522 (e.g., conduits 220, 222), a platform 524 (e.g., platform 224), wheels 526 (e.g., wheels 226), a control assembly 530 (e.g., control assembly 230), and a stanchion 532 (e.g., stanchion 232). Although containers (e.g., containers 216, 218) of the fluids used to form the multi-component compound are not shown in FIG. 5, the conduits 520, 522 may fluidly couple with such containers to separately supply the fluids to the transfer assembly 514. The system 500 also includes conduits 534 that fluidly couple the outlet ports of the transfer assembly 514 with the nozzles 202. These conduits 534 may define the portions of the separate flow paths that extend from the outlet ports of the transfer assembly 514 to the nozzles 502.

The system 500 also includes a ram 536 that can be actuated in a downward direction to cause an additional set of wheels 538 to engage the surface on which the system 500 is disposed. The movement of the ram 536 can cause another set of the wheels 526 that are powered (e.g., rotated) by the motor 528 to be lifted off the ground, so that an operator may manually push or pull the system 500.

With respect to the systems 100, 500, the nozzles 202, 502 can be positioned in a variety of locations in order to spray the multi-component compounds onto interior surfaces 104 of structures 102 of a variety of sizes. For example, the stanchion 232, 532 can be raised or lowered and/or the arms 204, 504 can be adjusted in order to spray the multi-component compounds onto interior surfaces 104 of cylindrical structures as small as four feet in diameter up to twenty-five feet in diameter. Alternatively, the sizes and/or ranges of motion of one or more components of the system 100, 500 may be adjusted to spray the multi-component compounds onto interior surfaces 104 of smaller or larger structures 102. For example, the systems 100, 500 may be sized to fit within even smaller structures, such as pipes or other conduits that are as small as one foot (e.g., 30.5 centimeters) or smaller.

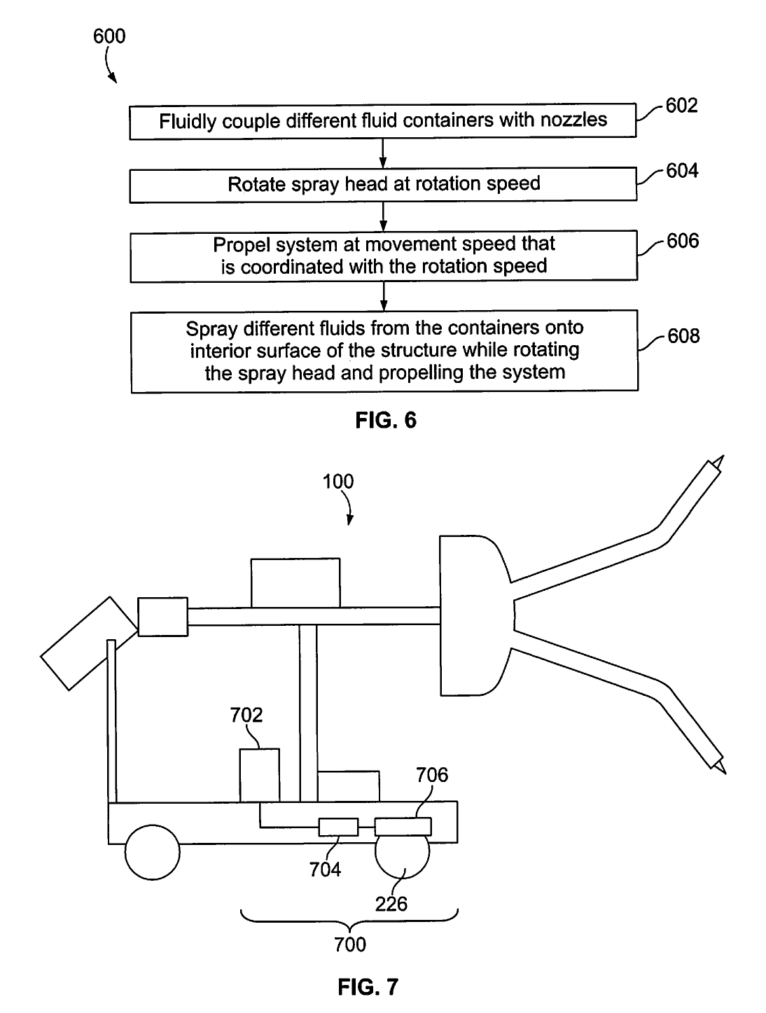

FIG. 6 is a flowchart of an embodiment of a method 600 for applying a multi-component compound onto an interior surface of a structure. The method 600 may be used in conjunction with the system 100 and/or the system 500 shown and described above.

At 602, different fluid containers are fluidly coupled with nozzles of the system. For example, fluid containers 216, 218 that supply the different fluids used to form the multi-component compound are fluidly coupled with nozzles 202, 502, such as by conduits, transfer assemblies 214, 514, and the like. The pathways through which the fluids are supplied from the containers to the nozzles may remain separate so that the fluids do not mix until just before or during the spraying of the fluids onto the interior surface 104 of the structure 102, as described above. Pumps 236, 238 may be used to force the fluids from the containers 216, 218 to the nozzles 202, 502.

At 604, the spray head 200, 500 of the system 100, 500 rotates at a rotation speed. The spray head 200, 500 may rotate without twisting the conduits that convey the fluids from the containers 216, 218 to the nozzles 202, 502. For example, the transfer assembly 214, 514 may convey the fluids between conduits connected with the stationary (e.g., non-rotating) containers 216, 218 and conduits connected with the rotating nozzles 202, 502.

At 606, the system 100, 500 is propelled at a movement speed that is coordinated with the rotation speed. At 608, the different fluids are sprayed as the multi-component compound onto the interior surface while the nozzles 202, 502 are rotated and the system 100, 500 is propelled along the inside of the surface 102. As described above, the movement and rotation speeds may be based on each other so that the coating formed by the multi-component compound is applied to the interior surface 104 of the structure 102 at a designated thickness.

During movement of the systems 100, 500 inside the structure 102, the systems 100, 500 may tend to move toward one or more of the interior surfaces 104. For example, if the direction of movement of the system 100, 500 is angled, even slightly angled, with respect to a center axis of the structure 102 (e.g., the center axis of the cylinder shape formed by the structure 102), then movement of the system 100, 500 can cause the system 100, 500 to move closer to one side of the structure 102 than other sides. As a result, the compound being sprayed onto the interior surface 104 of the structure 102 may not be applied evenly. The portions of the interior surface 104 that are closer to the system 100, 500 due to the angled movement of the system 100, 500 may receive thicker coatings of the compound than other portions of the interior surface 104.

In order to prevent this movement of the system 100, 500, the system 100, 500 can include an autonomous steering assembly. FIG. 7 is a schematic illustration of the system 100 with one example of such a steering assembly 700. The steering assembly 700 includes a distance sensor 702 coupled with a steering device 704. The distance sensor 702 measures distances between the system 100 and the interior surface 104 of the structure 102 in which the system 100 is moving. The distance sensor 702 can include a sonar device that measures distances to the interior surface 104 using sound or ultrasound waves, a radar device that measures these distances using radar, a laser or other light device that measures the distances using laser light or another light, or another device. For example, the sensor 702 alternatively may include a probe that engages the interior surface 104 to measure the distances. Such a probe may be an elongated body that contacts the interior surface 104 and is able to change shape by lengthening or shortening (e.g., such as by telescoping). Based on changes in length, the probe can be used to measure distances to the interior surface 104.

The steering assembly 700 can include one or more hardware circuits or circuitry that include and/or are coupled with one or more electronic logic devices, such as one or more processors, controllers, or the like. These circuits can monitor the distances to the interior surface 104 as measured by the sensor 702. These circuits and/or other components can be represented by the sensor 702 in FIG. 7. When the measured distances indicate that the system 100 is moving toward the interior surface 104 (e.g., is getting closer to one side of the interior surface 104 than another), the steering assembly 700 can direct the steering device 704 to actuate one or more wheels 226 of the system 100. For example, the steering assembly 700 can direct the steering device 704 to turn one or more of the wheels 226 to cause the system 100 to move more toward the center of the structure 104, instead of moving toward one or more sides of the structure 104. As described below, the steering device 704 can include one or more pistons that are actuated to push or pull a turning assembly 706 coupled with the wheel 226. This pushing or pulling of the turning assembly 706 causes the wheel 226 to turn, as described below.

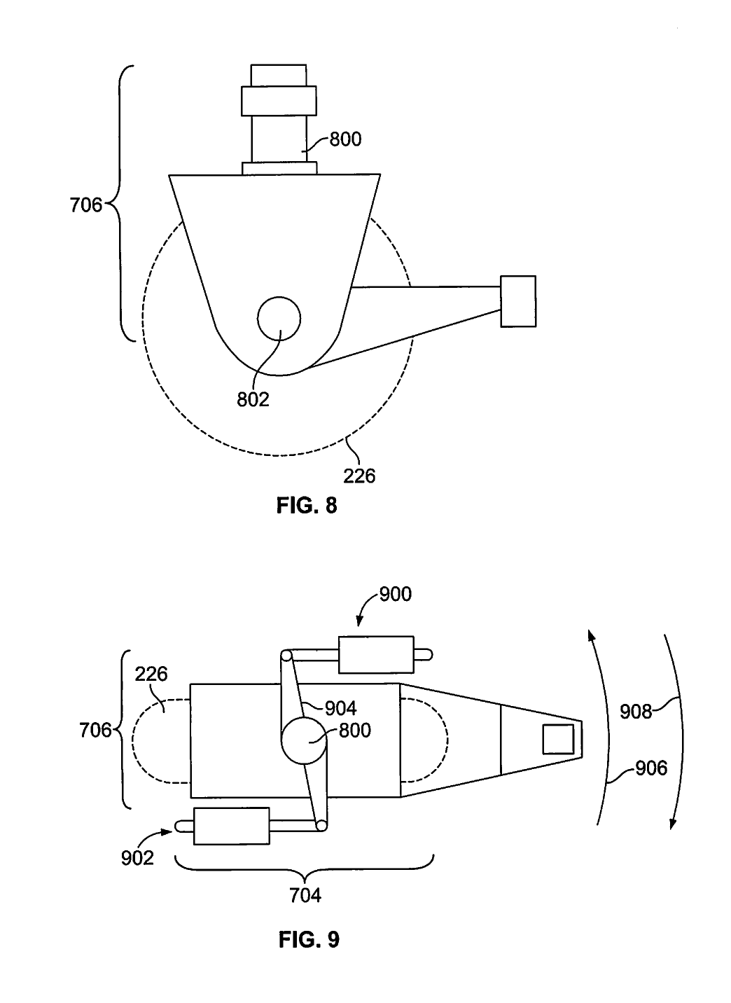

FIG. 8 is a side view of the turning assembly 706 of the steering assembly 700 shown in FIG. 7 according to one example of the inventive subject matter described herein. FIG. 9 is a top view of the steering device 704 and the turning assembly 706 of the steering assembly 700 shown in FIG. 8. The steering device 704 includes two pistons 900, 902 in the illustrated example. Optionally, the steering device 704 may include a single piston or another device that operates to change the direction in which the wheel 226 moves. The pistons 900, 902 are coupled with actuator arms 904. The actuator arms 904 extend from and are coupled with a steering axle 800. The wheel 226 rotates around a movement axle 802 to propel the system 100.

The steering axle 800 can be rotated to change the direction in which the wheel 226 moves. For example, when the piston 900 and/or the piston 902 extends outward (e.g., elongates) from the positions shown in FIG. 9, the arms 904 are pushed by the pistons 900, 902 and, as a result, the steering axle 800 rotates in a counter-clockwise direction from the perspective of FIG. 9. When the piston 900 and/or the piston 902 retreats in an opposite direction (e.g., shortens) from the positions shown in FIG. 9, the arms 904 are pulled and, as a result, the steering axle 800 rotates in a clockwise direction from the perspective of FIG. 9. By changing the positions of the pistons 900 and/or 902, the steering assembly 700 can control the turning of the wheel 226 and the system 100.

In operation, the distance sensor 702 can measure distances to the interior surface 104 and, when the steering assembly 700 determines that the system 100 is moving closer to the interior surface 104, the steering assembly 700 can actuate one or more of the pistons 900 and/or 902. This actuation can cause the piston 900 and/or 902 to elongate or shorten and, as described above, turn the wheel 226. The steering assembly 700 can automatically control the pistons to control the direction in which the system 100 is moving based on the measured distances so that the system 100 automatically remains in the center of the structure 102 approximately equidistant from the interior surfaces 104 of the structure 102.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the inventive subject matter without departing from its scope. While the dimensions, numerical values, and types of materials described herein are intended to define the parameters of the inventive subject matter, they are by no means limiting and are exemplary embodiments. Many other embodiments will be apparent to persons of ordinary skill in the art upon reviewing the above description. The scope of the inventive subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112(f), unless and until such claim limitations expressly use the phrase “means for” followed by a statement of function void of further structure.

The methods described herein may be performed using one or more tangible and non-transitory components, such as one or more processors, controllers, computers, or other devices. The operations described in connection with the methods may be directed by one or more sets of instructions stored on a tangible and non-transitory computer readable medium. For example, software code stored on a tangible and non-transitory memory may be used to direct one or more processors to carry out the operations of the methods.

This written description uses examples to disclose several embodiments of the inventive subject matter and also to enable a person of ordinary skill in the art to practice the embodiments of inventive subject matter, including making and using any devices or systems and performing any incorporated methods. The patentable scope of the inventive subject matter is defined by the claims, and may include other examples that occur to persons of ordinary skill in the art. Such other examples are intended to be within the scope of the claims if they have structural elements that do not differ from the literal language of the claims, or if they include equivalent structural elements with insubstantial differences from the literal languages of the claims.

What is claimed is:

1. A spray coating system comprising:
a rotating spray head coupled with at least one spray nozzle that is configured to direct spraying of a fluid multi-component product onto an interior surface of a structure, the spray head configured to rotate around a longitudinal axis in order to cause the at least one spray nozzle to also rotate around the longitudinal axis while spraying the multi-component product onto the interior surface of the structure; and
a transfer assembly fluidly coupled with the at least one spray nozzle and configured to supply plural different fluids that form the multi-component product to the at least one spray nozzle for spraying the multi-component product onto the interior surface of the structure,
wherein the transfer assembly is configured to supply the different fluids that form the multi-component product to the at least one spray nozzle without mixing the different fluids with each other prior to the different fluids being disposed proximate to the at least one spray nozzle.

2. The system of claim 1, wherein the spray head is configured to be rotated by rotation of a spray head axle and the transfer assembly is configured to convey the different fluids that form the multi-component product at least one of through or along the spray head axle as the spray head axle rotates without also rotating respective different supply containers of the different fluids.

3. The system of claim 1, further comprising a transport assembly configured to propel the spray head and the transfer assembly in one or more directions oriented parallel to the longitudinal axis as the spray head rotates and the at least one spray nozzle sprays the multi-component product onto the interior surface of the structure.

4. The system of claim 3, further comprising a control assembly configured to control rotation of the spray head and movement of the spray head and the transfer assembly by the transport assembly, wherein the control assembly is configured to coordinate a speed of rotation of the spray head with a speed of movement at which the transport assembly moves the spray head and the transfer assembly.

5. The system of claim 4, wherein the control assembly is configured to coordinate the speed of rotation with the speed of movement in order to apply the multi-component product onto the interior surface of the structure at a designated coating thickness.

6. The system of claim 3, wherein the transport assembly includes a spark-free air motor that is pneumatically powered and controlled to propel the spray head and the transfer assembly.

7. The system of claim 1, wherein the spray head is coupled with the at least one spray nozzle by at least one arm, the at least one arm configured to be moved relative to the spray head to control an angle at which the at least one spray nozzle is oriented relative to the interior surface of the structure.

8. The system of claim 1, further comprising a stanchion coupled with a spray head axle that rotates the spray head, the stanchion configured to raise or lower the spray head axle and the spray head relative to the interior surface of the structure.

9. The system of claim 1, wherein each of the at least one spray nozzle is supplied with the different fluids such that each of the at least one spray nozzle concurrently sprays the different fluids onto the interior surface of the structure.

10. A method for applying a fluid multi-component product to an interior surface of a structure, the method comprising:
rotating a spray head around a longitudinal axis, the spray head coupled with at least one spray nozzle;
supplying the at least one spray nozzle with plural different fluids that form the multi-component product via a transfer assembly; and
spraying the different fluids that form the multi-component product onto the interior surface of the structure from the at least one spray nozzle, the different fluids sprayed from the at least one spray nozzle as the at least one spray nozzle rotates around the longitudinal axis,
wherein the different fluids that form the multi-component product are supplied to the at least one spray nozzle without mixing the different fluids with each other prior to the different fluids being disposed proximate to the at least one spray nozzle.

11. The method of claim 10, wherein the different fluids are supplied from different respective supply containers without also rotating the supply containers.

12. The method of claim 10, further comprising propelling the spray head and the transfer assembly in one or more directions oriented parallel to the longitudinal axis as the spray head rotates and the at least one spray nozzle sprays the multi-component product onto the interior surface of the structure.

13. The method of claim 12, wherein rotating the spray head and propelling the spray head and the transfer assembly includes coordinating a speed of rotation of the spray head with a speed of movement at which the transport assembly moves the spray head and the transfer assembly.

14. The method of claim 13, wherein the speed of rotation is coordinated with the speed of movement in order to apply the multi-component product onto the interior surface of the structure at a designated coating thickness.

15. The method of claim 10, further comprising modifying an angle at which the at least one spray nozzle is oriented relative to the interior surface of the structure.

16. The method of claim 10, further comprising at least one or raising or lowering the spray head relative to the interior surface of the structure.

17. A system comprising:
a transport assembly comprising a mobile platform and a motor configured to propel the platform along a designated direction;
a spray head axle rotatably coupled with the transport assembly, the spray head axle configured to rotate around an axis that is parallel to the designated direction; and
a spray head coupled with the spray head axle and including at least one spray nozzle, the spray head and the at least one spray nozzle configured to be rotated around the axis by rotation of the spray head axle,
wherein the transport assembly is configured to propel the platform, the spray head axle, and the spray head along the designated direction while the spray head and the at least one spray nozzle are rotated around the axis, the at least one spray nozzle configured to apply one or more fluids to an interior surface of a structure in which the transport assembly, the spray head axle, and the spray head are disposed.

18. The system of claim 17, further comprising a transfer assembly fluidly coupled with the at least one spray nozzle, the transfer assembly configured to supply plural different fluids that form a multi-component product to the at least one spray nozzle for spraying the multi-component product onto the interior surface of the structure, wherein the transfer assembly is configured to supply the different fluids without mixing the different fluids with each other prior to the different fluids being disposed proximate to the at least one spray nozzle.

19. The system of claim 17, wherein the spray head is configured to be rotated by rotation of a spray head axle and the transfer assembly is configured to convey the different fluids that form the multi-component product at least one of through or along the spray head axle as the spray head axle rotates without also rotating respective different supply containers of the different fluids.

20. The system of claim 17, further comprising a control assembly configured to control rotation of the spray head and movement of the spray head and the transfer assembly by the transport assembly, wherein the control assembly is configured to coordinate a speed of rotation of the spray head with a speed of movement at which the transport assembly moves the spray head and the transfer assembly.
